(19) United States
(12) Patent Application Publication
(10) Pub. No.: US 2010/0194562 A1
(43) Pub. Date: Aug. 5, 2010

(54) FAILURE RECOGNITION SYSTEM

(76) Inventors: Jong-Moon Lee, Changwon-si (KR); Ki-Won Sung, Changwon-si (KR); Jae-Eok Kim, Changwon-si (KR)

Correspondence Address: SHERR & VAUGHN, PLLC, 620 HERNDON PARKWAY, SUITE 320, HERNDON, VA, 20170, US

(21) Appl. No.: 12/696,042

(22) Filed: Jan. 28, 2010

(30) Foreign Application Priority Data
Jan. 30, 2009 (KR) 10-2009-0007612
Jan. 30, 2009 (KR) 10-2009-0007630
Jul. 17, 2009 (KR) 10-2009-0065298

(51) Int. Cl. G08B 21/00

(52) U.S. Cl. 340/540; 348/125; 382/141

(57) ABSTRACT

A failure recognition system is disclosed. A failure recognition system includes a learning stage (S10) learning and acquiring information related to a good product and failure; a setting stage (S100) setting reference information to determine a failure of a product; a product inspecting stage (S150) inspecting the product based on the reference set in the setting stage (S100); a product recognizing stage (S160) recognizing an item and type of the product by specifying an image of the product measured in the product inspecting stage (S150); a product quality determining stage (S170) determining whether the product is a good product or failure from the image finally recognized in the product recognizing stage (S160) based on the information acquired in the learning stage (S10); and a follow-up stage (S180) notifying the failure outside and controlling an equipment according to a control method set in the setting stage (S100) simultaneously.

### CROSS REFERENCE TO RELATED APPLICATION

This application claims the benefits of the Patent Korean Applications No. 10-2009-0007612, 10-2009-0007630 filed on Jan. 30, 2009 and No. 10-2009-0065298 filed on Jul. 17, 2009, which are hereby incorporated by reference as if fully set forth herein.

### BACKGROUND OF THE DISCLOSURE

1. Field of the Disclosure

The present invention relates to a failure recognition system, more particularly, to an optimal failure recognition system based on HTM that is able to detect a failure of a product based on an optimal learning system.

2. Discussion of the Related Art

In general, to detect a failure of a product molded by predetermined work, for example, pressing work and the like, a worker has to see the product to find the failure for himself. In other words, each of the products has to be recognized visibly by the worker's individual determination and the failure and good products may be determined accordingly.

In this case, each of the products has to be detected and this may cause a problem of deteriorating work efficiency. Also, inspection criteria may be changeable according to the worker's condition. That is, since the inspection criteria may be changed according to the worker's condition, product quality determination may be subjective disadvantageously.

Recently, a method for recognizing a shape of a product based on an artificial intelligence or neural network theory has been introduced. However, the method using the artificial intelligence or neural network theory has to program and set all of corresponding criteria, for example, set a corresponding product and set a parameter corresponding to the product and the like.

Specifically, in case of determining the shape of the product based on the conventional artificial intelligence or neural network theory, many input neurons are required enough to require a long learning time of such a neural network and a much calculating time.

Moreover, the shape determination is performable with respect to a predetermined product. As a result, the corresponding program has to be changed and a criterion of the corresponding product has to be set each time to determine the shapes of the other products.

Also, since an auxiliary learning system for determining and practicing failure and good quality is not provided, each of images has to be added and the failure and good quality has to be recognized to set add a new or existing image of failure recognition to the failure recognition system. Only if the corresponding image is added in this case, the determination of the failure is possible disadvantageously.

### SUMMARY OF THE DISCLOSURE

Accordingly, the present invention is directed to a failure recognition system.

An object of the present invention is to provide a learning method of an optimal failure recognition system enabling accurate determination of a failure in a real work place.

Another object of the present invention is to provide a learning method of a failure recognition system having high accuracy, with a short learning time.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a failure recognition system includes a learning stage (S10) learning and acquiring information related to a good product and failure; a setting stage (S100) setting reference information to determine a failure of a product; a product inspecting stage (S150) inspecting the product based on the reference set in the setting stage (S100); a product recognizing stage (S160) recognizing an item and type of the product by specifying an image of the product measured in the product inspecting stage (S150); a product quality determining stage (S170) determining whether the product is a good product or failure from the image finally recognized in the product recognizing stage (S160) based on the information acquired in the learning stage (S10); and a follow-up stage (S180) notifying the failure outside and controlling an equipment according to a control method set in the setting stage (S100) simultaneously.

According to the present invention, without any auxiliary operation with respect to plural products, quality determination may be performed by learning. As a result, work efficiency is enhanced and quality is improved advantageously. That is, even in case a type of a product is differentiated, the corresponding type is automatically distinguished by the learning and it is determined whether the product is a good product or failure based on a quality standard of the corresponding product. According to the present invention, the learning and determination which is closer to human ability may be possible such that quality determination work may be performed more efficiently.

Furthermore, according to the present invention, an optimal value of ‘Sigma’ is provided and ‘Sigma’ is an important parameter required in the number of times required for an image sensor to read images randomly and in ‘MaxDistnace’ having vectors considered as generated simultaneously therein and in an inference process. As a result, the learning time is reduced and accuracy of the failure determination is enhanced.

A still further, it is possible to add data to the existing category simply, rather than forming a new category. As a result, the category formation and category update is freely performed.

A still further, it is provided in the present invention to determine whether the learning result satisfies the required result value. As a result, the best accurate one of the learning results is provided in the failure recognition system and used in a real work place and thus the failure determination may be more accurate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a block view schematically illustrating a configuration of a failure recognition system according to an exemplary embodiment of the present invention;

FIG. 2 is a flow chart illustrating a learning method composing the failure recognition system;

FIG. 3A to 3E is a screen illustrating each stage of the failure recognition system;

FIG. 4 is a diagram illustrating an experiment result of accuracy according to the data number of good products and failures;

FIGS. 5A and 5B are diagram and graph illustrating an experiment result testing accuracy according to change of ‘iteration’ number;

FIG. 6A to 6C are diagrams and graphs illustrating experiment results to search an optimal value of ‘MaxDistnace”

FIGS. 7A and 7B are a diagram and graph illustrating results of accuracy according to change of ‘Sigma’;

FIG. 8 is a diagram illustrating specific steps of a product inspecting stage;

FIG. 9 is a diagram illustrating results of accuracy change according to increased contrast;

FIG. 10 is a diagram illustrating a product recognizing stage;

FIG. 11 is a flow chart illustrating usage state of the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

As follows, a failure recognition system according to an exemplary embodiment of the present invention will be described.

The present invention relates to a system for recognizing a quality of a product by using a recognition engine based on HTM (Hierarchical Temporal Memory).

A HTM model is referenced to as Neocortex mechanism capable of controlling human intelligence. That is, the HTM model is a computational model of Neocortex modeling operation of both neuron and synapsis of a human brain which is suggested by Dr. Hawkins.

Such the HTM model is different from an artificial intelligence (hereinafter, AI) based on conventional Huristic search or artificial neural network (hereinafter, ANN) that is connection of simple neurons.

According to the HTM, a basic unit of six-layered Neocortex, that is, Neocortex column may be a unit node as basic unit of a network which is configured of approximately 1,000 neurons and 1,000,000 synapses. And the unit nodes compose a hierarchy network to memorize spatial-temporal pattern information, especially, temporal information of world in order to perform intelligent judgment efficiently.

As a result, recognition for the world is more efficient and robust than the conventional AI or ANN.

More specifically, the HTM has:

(i) Meaning of ‘hierarchical’, that is, the HTM is configured of a hierarchic of tree-shaped nodes. Each of the nodes has learning and memory functions and an algorithm to perform the function. Low level nodes process a lot of inputs received from outside and they transfer the result of the process to next level nodes.

(ii) Meaning of ‘temporal’, that is, HTM application shows a corresponding object getting changed temporally. For example, during the learning of picture application, the HTM shows the image as if it is temporally getting changed from a top to a bottom from a left side to right side. Here, such a temporal element is quite important and the algorithm is set to expect inputs getting changed temporally.

(iii) Meaning of memory, that is, the HTM application is operated in two stages, specifically, learning the memory and using the memory in reasoning. During the learning, a HTM network learns to recognize a pattern from the inputs. Here, the learning is performed separately in each level of the hierarchy.

Once the learning of the network is completed, each level of the hierarchy has all the objects of its world in its memory.

The HTM network receives a new object during the next reasoning and recognizing to determine that the new object is the most likely one of the objects.

Such the HTM is a new computing paradigm that models human neocortex in an aspect of software.

If using the HTM, a pattern shown in a sensor data may be found and excellence of performance has proven in several simple applications including image recognition, diagram recognition and wave recognition.

The present invention uses such the HTM in determining quality assurance of manufacturing plants. That is, the present invention is a system capable of determining quality circumstances in or between processes by using data collected from diverse sensors, for example, image, temperature, humidity and dust sensors).

According to a recognition engine based on the HTM, plural images are categorized based on similarity and they are determined, in case that plural image are mixed. This is like a child who recognizes a similar object as train or airplane regardless of the size, after recognizing a train or airplane in a picture or real.

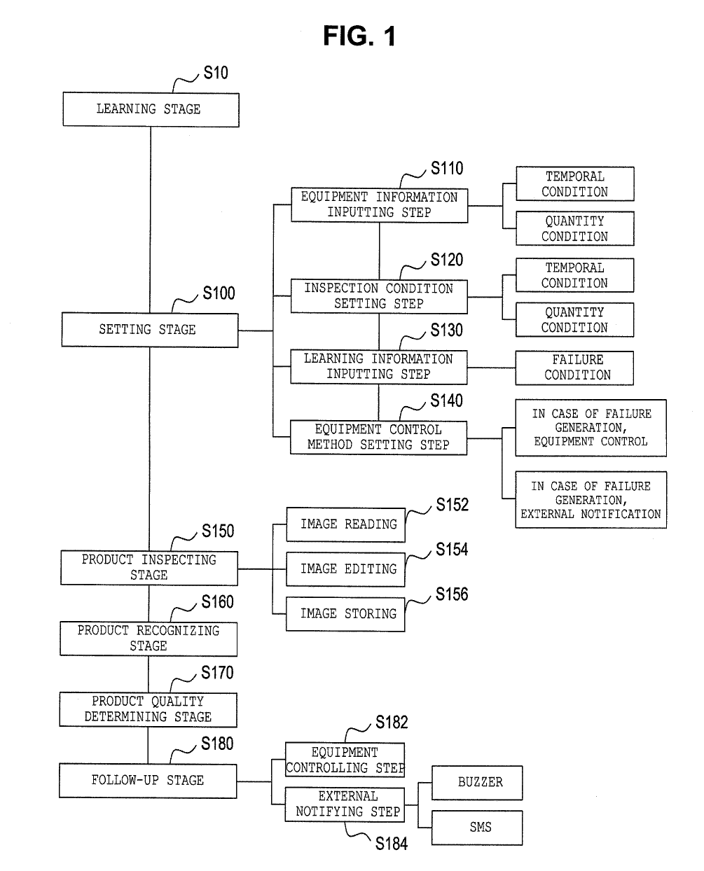

FIG. 1 is a block view schematically illustrating a failure recognition system according to an exemplary embodiment of the present invention.

As shown in FIG. 1, the failure recognition system includes a learning stage (S10), a setting stage (S100), a product inspecting stage (S150), a product recognizing stage (S160), a product quality determining stage (S170) and a follow-up stage (S180). The learning stage (S10) acquires information related to a good product or failure by learning. The setting stage (S100) sets reference information of a system to determine whether the product is a failure. The product inspecting stage (S150) inspects products based on the reference set in the setting stage (S100). The product recognizing stage (S160) specifies an image of the product measured in the product inspecting stage (S150) and it recognizes a type and a shape of the product. The product quality determining stage (S170) determines a failure of the product from the image finally recognized in the product recognizing stage (S160) based on the information acquired in the learning stage (S10). In case the product quality determining stage (S170) determines that there is a failure of the product, the follow-up stage (S180) informs the failure outside and it controls equipment based on a control method set in the setting stage (S100) simultaneously.

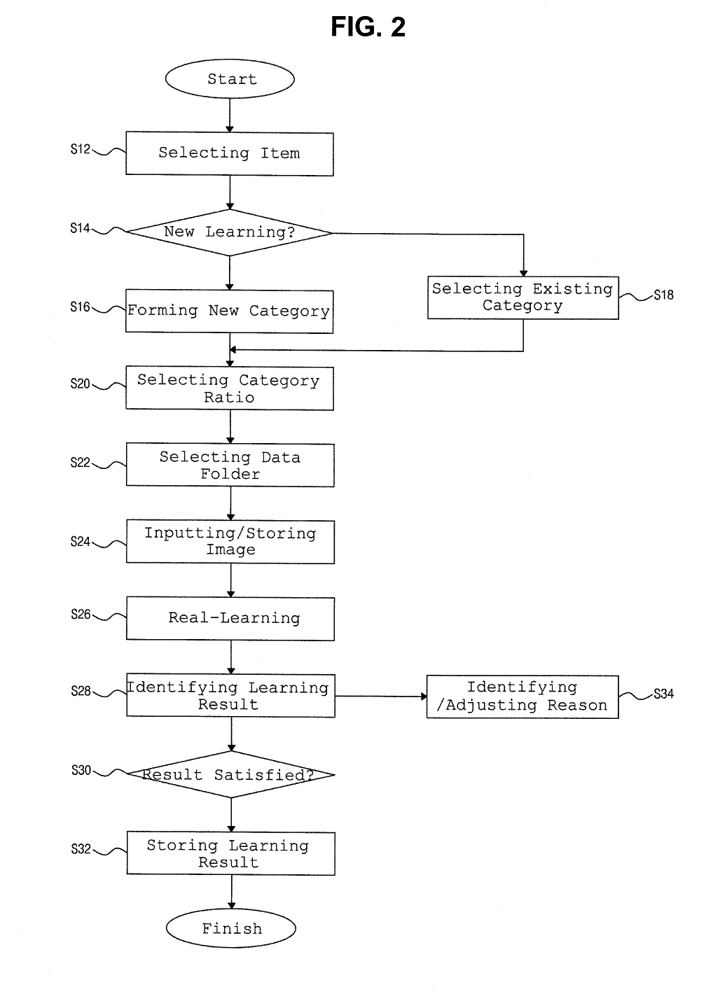

An embodiment of the learning stage (S10) is shown in FIG. 2 specifically.

As shown in FIG. 2, the learning stage (S10) includes an item selecting step (S12), a type determining step (S14), a category forming step (S16), a category selecting step (S18), a ratio selecting step (S20), a folder selecting step (S22), a inputting step (S24), a testing step (S26), an identifying step (S28), a result determining step (S30) and a storing step (S32). The item selecting step (S12) selects an item to learn and the type determining step (S14) determines whether the item is new learning or continuing the former learning. The category forming step (S16) forms a new category in case of the new learning based on the result of the determining in the type determining step (S14). The category selecting step (S18) selects an existing category in case that it is the continuing of the former learning based on the result of the determining in the type determining step (S14). The ratio selecting step (S20) selects a ratio of data number to learn with respect to each category. The folder selecting step (S22) selects a folder to store image data learned for each category. The inputting step (S24) receives and stores input images. The testing step (S26) tests a real product and the identifying step (S28) identifies the result of the testing step (S26). The result determining step (S30) determines whether the result of the test identified in the identifying step (S28) satisfies a value of the required learning result. The storing step (S32) stores the result of the learning if the result of the determining in the result determining step (S30) is satisfied.

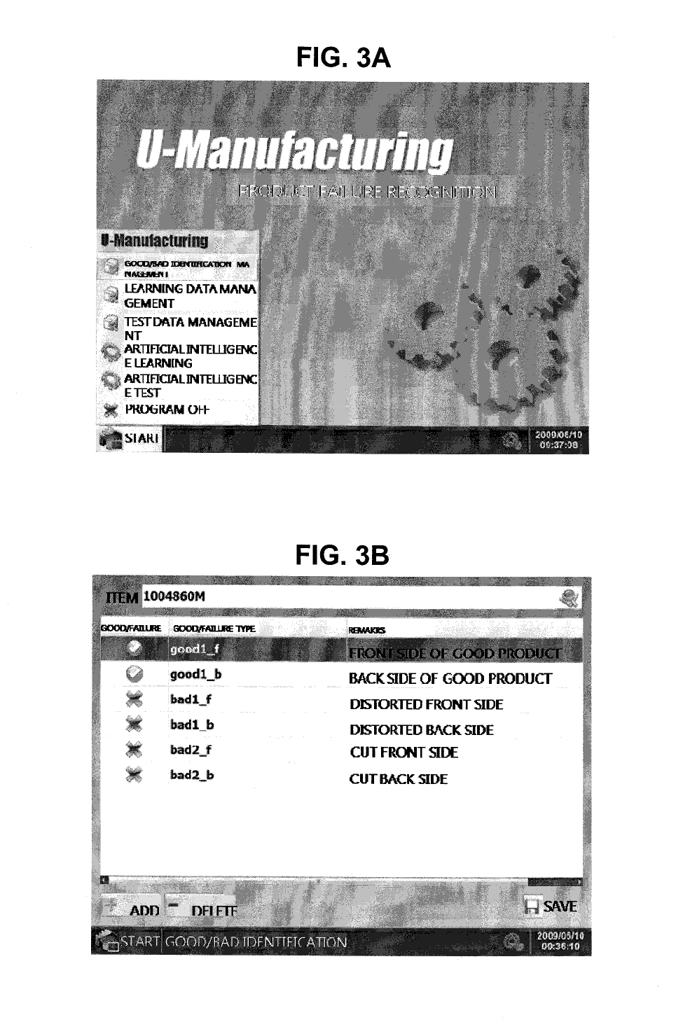

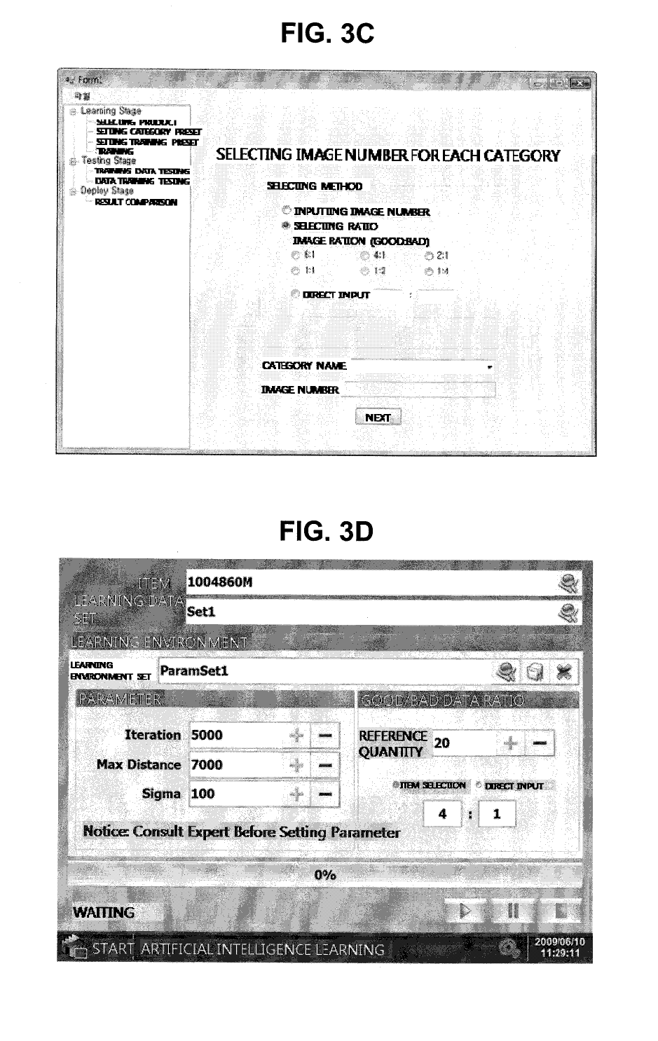

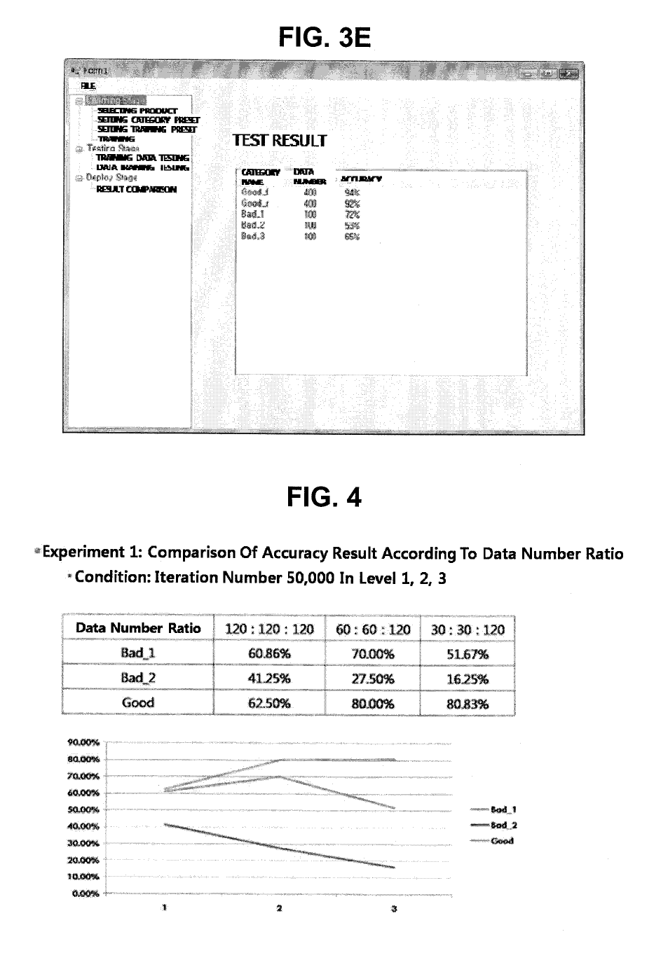

FIG. 3A illustrates an example of a main screen to perform the learning step (S10). As shown in FIG. 3A, good and bad products and learning data and testing data are managed.

The type determining step (S14) determines whether contents to learn are for a new product or for a product learned before which is required to be additionally learned.

Based on the result of the determination in such the type determining step (S14), the category forming step (S16) or the category selecting step (S18) may be performed.

The category forming step (S16) forms a new category to store image data of a new product to learn.

In this process, a good category and a failure category are generated and the failure category includes various categories such as Bad 1, Bad 2, and the other based on the kind of failure.

For example, Bad 1 is a type of distortion generated in some area of the product and Bad 2 is a type of carving cut generated in some area of the product and ‘the other’ is a category of products which belong to none of the categories, with not being good products.

FIG. 3B is a screen illustrating an example of types of categories formed in the category forming step (S16).

The category selecting step (S18) selects a corresponding one of the product from the existing categories and it selects and specifies a category to store a learning image input newly.

Once the category forming step (S16) or the category selecting step (S18) is complete, the ratio selecting step (S20) starts.

The ratio selecting step (S20) determines the ratio of each category to perform the learning. That is, the ratio selecting step (S20) selects the ratio of the number of images to learn. Here, the ratio of the image data to learn good products and failures is set similar to the ratio of good products to failures generated in real work places. It is preferable that the basic ratio of the good products to the failures to learn is identical to the ratio generated in the real work place.

The ratio selecting step (S20) selects the ratio of the number of the image data to learn in a type of Good:Bad 1:Bad 2 by 4:1:1. Such the ratio selecting step (S20) will be described in detail as follows. FIG. 3C shows a screen to select the ratio of the good product images to the failure images according to the ratio selecting step (S20).

The inputting step (S24) inputs images stored in advance to determine the failure of the product or it receives and stores therein input images of the good product and failure after a test.

In case scanned images of the product are pre-stored in a computer, such image data is called and it is determined whether the product is a failure based on the called image data.

If the images are not stored, the real product is placed in a line to read the images of the product and the images are categorized and stored based on a type. In a state of the image sensor being operated, the real good product or failure is moved in the line and images of the product is inputted via the image sensor and the input images are stored.

If information related to the good product and failure is inputted during the inputting step (S24), the testing step (S26) starts to test a real product based on the learned information on the failure.

The testing step (S26) determines whether a value read via the sensor with the real product is moved in the line is corresponding to a good product or failure. Diverse parameters are adjusted to perform the test. That is, an optimal parameter value is automatically set by the artificial intelligence and the test is performed based on the optimal parameter value. FIG. 3D shows a screen to set such the parameter value. The testing step (S26) will be described later.

The identifying step (S28) identifies whether the experiment result of the testing step (S26) is operated properly. It is identified whether the determination for the failure is performed properly according to the learned types.

FIG. 3E shows a screen in a state of identifying a test data value generated in the testing step (S26).

The result determining step (S30) determines whether the test result identified in the identifying step (S28) is a required value. For example, in case at least 100% accuracy is required, the result determining step (S30) determines whether the test result of the identifying step (S28) has more than 90% accuracy.

The storing step (S32) stores the learning result if the required accuracy is satisfied to make the learning result applicable to real work places. Specifically, after comparing each test results, the storing step (S32) transfers the most accurate learning result to the failure recognition system to be applied to the real work place.

If the result of the determination in the result determining step (S30) fails to satisfy the required accuracy, an adjusting step (S34) is performed to identify and adjust the reason of the not satisfied result. In case the test result does not have the required accuracy, an error type is analyzed and identifies why the determination error occurred and the error is corrected.

For example, in case the error is generated by wrong selection of the corresponding item, the item selecting step (S12) re-starts and a right item is selected to perform the learning.

In case the errors are focused on some good and failure types by the wrong ratio of the good products to the failures, the ratio selecting step (S20) re-starts and the ratio is adjusted to re-perform the learning.

FIG. 4 shows an experimental process to search the optimal data number in the ratio selecting step (S20). That is, FIG. 4 illustrates a corresponding percentage of Bad 1, Bad 2 and Good in case the ratio of the data number of Good, Bad 1 and Bad 2 is differentiated.

As shown in FIG. 4, the percentage is Bad 1:Bad 2:Good=60. 86%:41.25%:62.50% in case of the ratio of Bad 1:Bad 2:Good=120:120:120 in Level 1. The percentage is Bad 1:Bad 2:Good=70.00%:27.50%:80.00% in case of the ratio of Bad 1:Bad 2:Good=60:60:120 in Level 2. The percentage is Bad 1:Bad 2:Good=51.67%:16.25% 80:80.38% in case of the ratio of Bad 1:Bad 2:Good=30:30:120.

According to the result of the comparison between the percentage with the real percentage in the work place, the ratio selecting step (S20) may select the optimal ratio of the image data number is Good:Bad 1:Bad 2=4:1:1 in case of the type of Good, Bad 1 and Bad 2.

Even though the percentage of the good products is high and the percentage of the failures is quite low in the real work place, Level 1 and Level 2 of the above learning experiment have the too high percentage of the failures. If then, many good products might be determined as failures only to stop production lines occasionally. The ratio of the image data number, Good:Bad 1:Bad 2=4:1:1 may enhance the accuracy of the failure determination.

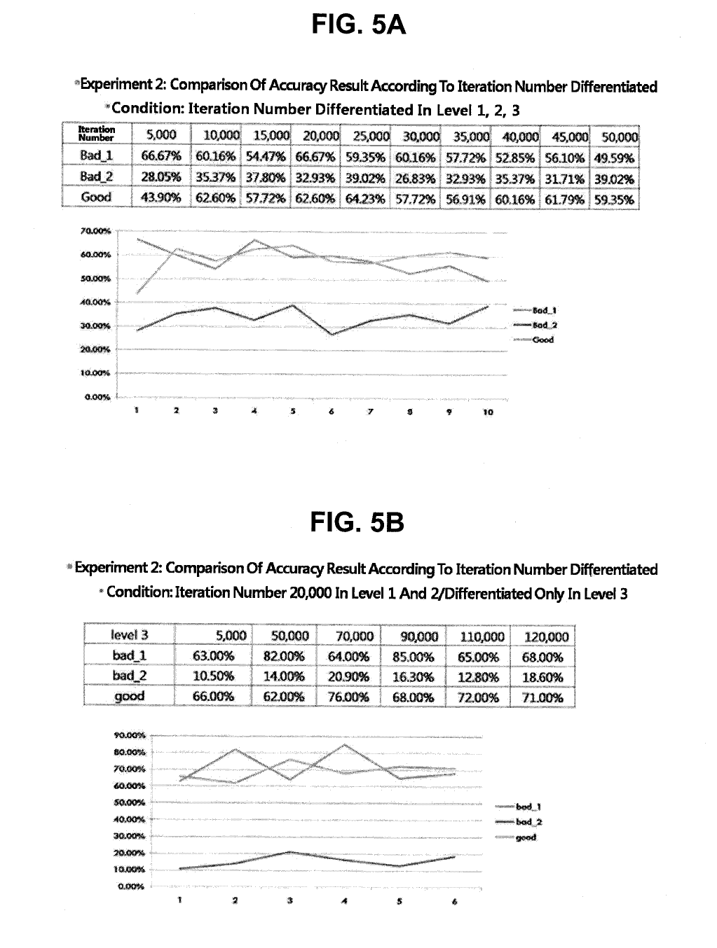

FIGS. 5A to 7B illustrate the result of the accuracy according to changes of parameters. It is shown which parameter is best to make more accurate determination.

FIGS. 5A and 5B show the result of an experiment that tests accuracy according to changes of the number of ‘iteration’. Here, ‘iteration’ means the number of times in which the image sensor reads plural images randomly in the testing step (S26). In other words, FIG. 5A shows a result value of the experiment in case the iteration number is identical in Level 1 and Level 2. FIG. 5B shows a result value in case the iteration number is identical in Level 1 and Level 2 and differentiated in Level 3.

According to the result of the experiments, Level 1 to Level 3 shown in FIG. 5A has almost no change and FIG. 5B has almost no effect of the change of the iteration number. As a result, it can be judged that the large or small iteration number does not affect the accuracy of the failure determination.

If the iteration number is increased unnecessarily, performance ability of the computer is limited and the learning time is lengthened. It is preferable that the iteration number is more than 5,000, specifically, that at least iteration number is approximately 5,000.

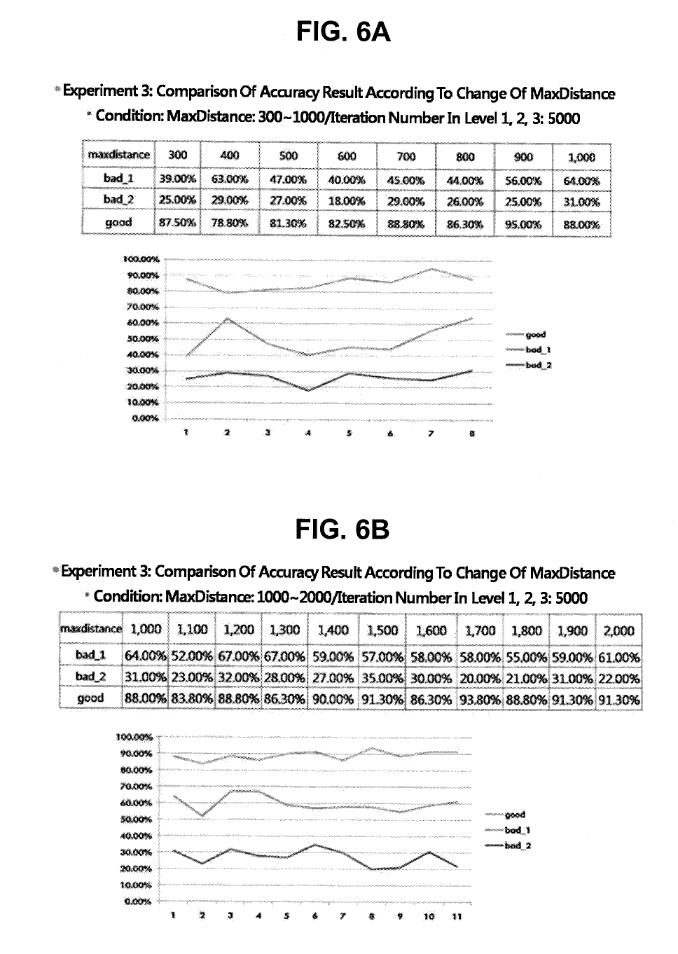

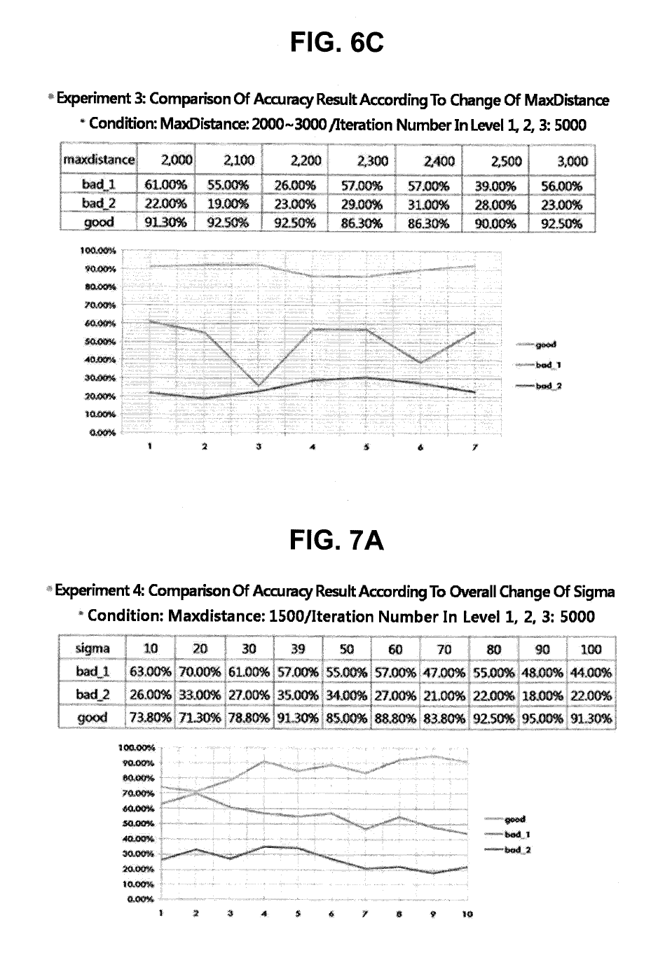

FIGS. 6A to 6C shows a result of an experiment that calculates an optimal value of ‘MaxDistance’. Here, ‘MaxDistnace’ is a parameter of the HTM recognition engines used in the present invention. Specifically, ‘MaxDistance’ is a distance in which the maximum distance of input vectors is set from a stored value while the learning is performed in Euclidean distance to consider the vectors within the maximum distance as generated simultaneously. In other words, ‘MaxDistnace’ is the maximum distance from a single reference sensor between an original image and a predetermined image compared with the original image. If a small value of such ‘MaxDistnace’ is set, more accurate comparison may possible. However, if a too small value of ‘MaxDistnace’ is set, the performance ability of the computer is limited to make the learning unperformable and the learning time is too long. As a result, it is preferable that a small value of ‘MaxDistnace’ as possible not to affect the accuracy of the failure is searched.

Considering such the environmental conditions, the MaxDistance' may be approximately 1400 to 1900. In this range, the percentage of the good products is high with the small value of ‘MaxDistnace’ such that the accuracy may be quite high. The optimal value of ‘MaxDistnace’ is 1,500.

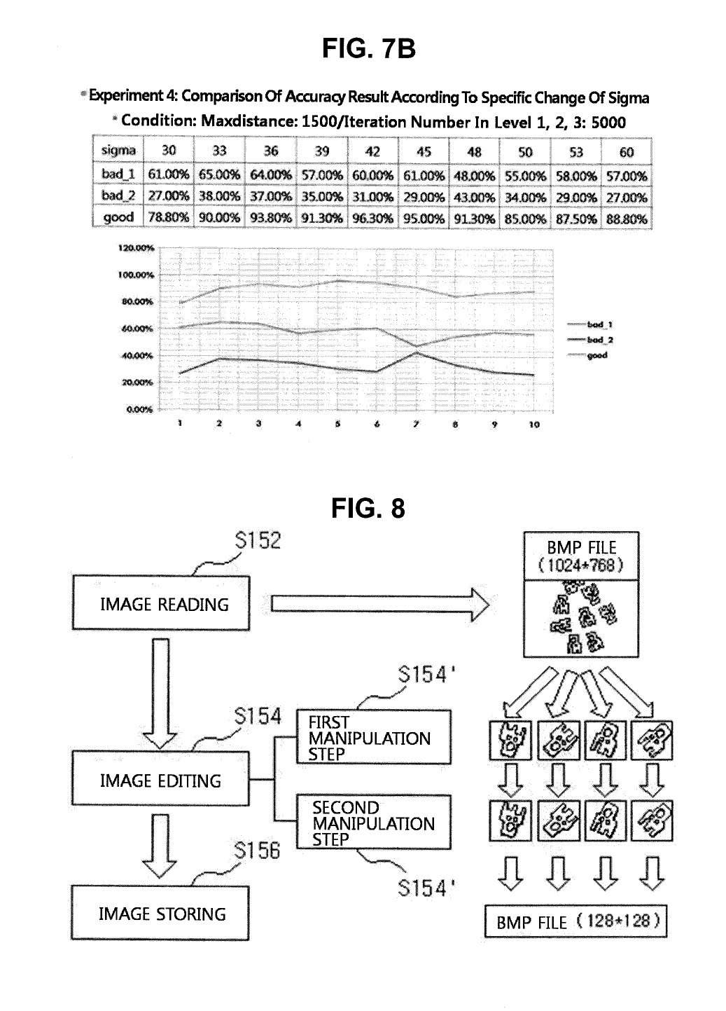

FIGS. 7A and 7B are experimental data comparing the results of accuracy according to changes of ‘Sigma’. ‘Sigma’ is a parameter required in an inference process, to specify a range of number of cases simultaneously generated as standard deviation. In other words, ‘Sigma’ is a parameter to set the degree of noses within the comparison range. As the accuracy is differentiated according to the degree of noise, it is important to set a proper sigma value and to find out a sigma value causing the highest accuracy.

As shown in the result of the experiment, the sigma value affects the accuracy seriously and such the sigma value makes the highest accuracy near a square root value of ‘MaxDistnace’. That is, if ‘MaxDistnace’ is 1,500 in the experiment, the accuracy is the highest near 38. 7 which is a square root value of 1,500.

In the meanwhile, the setting stage (S100) includes an equipment information inputting step (S110), an inspection condition setting step (S120), a quality standard setting step (S130) and an equipment control method setting step (S140). The equipment information inputting step (S110) inputs product manufacturing equipment information and sensor information to measure environmental conditions, for example, a pressure, temperature and like. The inspection condition setting step (S120) sets temporal and quantity conditions to perform the product inspection. The quality standard setting step (S130) loads the information learned in the learning stage (S10) as determination standard to determine a failure of each product. The equipment control method setting step (S140) sets a control method for the equipment in case the failure is generated.

The equipment information inputting step (S110) inputs information related to the equipment producing the products and other sensors. As the failure recognition system according to the present invention determines the images of the products during the production lines to determine whether the product is a failure or good product, the failure recognition system has to be in communication with the equipment and the information related on such the equipment has to be inputted.

Diverse sensors are installable in the failure recognition system according to the present invention to determine the product quality during the production. Specifically, not only the image sensor but also the sensors for sensing the temperature, humidity and dust may be installed and the information related to these sensors may be inputted in advance.

The equipment information and the sensor information should be matched.

The inspection condition setting step (S120) sets how to inspect the products. Here, a temporal condition or quantity condition may be typically set. For example, the inspection is set to be performed one time per 10 seconds or 1 minute, or the inspection is set to be performed with respect to one of 10 or 20 products.

The quality standard setting step (S130) sets information related to determination of the good product or failure. That is, the information related to the states of the good product and failure learned in the learning stage (S100) is inputted and the determination standard is set based on the input information.

The equipment control method setting step (S140) sets a control method in case the failure is generated and it notifies a failure generation state outside. Here, if the failures are generated continuously, the equipment is stopped to operate and this situation is notified outside via a buzzer and to a remote user via SMS (Short Message Service) simultaneously. The failure situation may be set to be transferred to the user's mobile phone via SMS.

Here, the continuous failure generation situation may be changeable according to the quality requirement of the product or the user's intention. If three failures are generated continuously, the equipment may be stopped to operate and the failure situation may be notified outside simultaneously. If three failures are generated continuously, only the notification function may be operated and if ten failures are generated continuously, the equipment may be stopped to operate.

The product inspecting stage (S150) includes image reading 152 and image editing 154 and image storing 156. The image reading 152 reads images of the product after photographing. The image editing 154 edits the images read by the image reading 152. The image storing 156 stores the image manipulated by the image editing 154.

FIG. 8 shows specific process of the product inspecting stage (S150).

As shown in FIG. 8, the image reading 152 of the product inspecting stage (S150) reads the images of the product photographed by a photographing device 200 in BMP file. Here, plural products are inputted in a single image having resolution of 1024×768.

The image editing 154 of the product inspecting stage (S150) converts the images read by the image reading 152 into binary images. The image editing 154 includes a first manipulation step (S154′) and a second manipulation step (S154″). The first manipulation step (S154′) locates an outline of each product and it cuts each outline. The second manipulation step (S154″) adjusts brightness and contrast of the image having passed the first manipulation step (S154′) to help image determination performed smoothly.

The first manipulation step (S154′) is a crop process for cutting the products one by one and the second manipulation step (S154″) is a contrast process for increasing sharpness by adjusting the brightness and contrast.

The image storing 156 of the product inspecting stage (S150) stores the BMP image file having passed the image editing 154. As shown in FIG. 8, the images are stored in each BMP image file having resolution of 128×128.

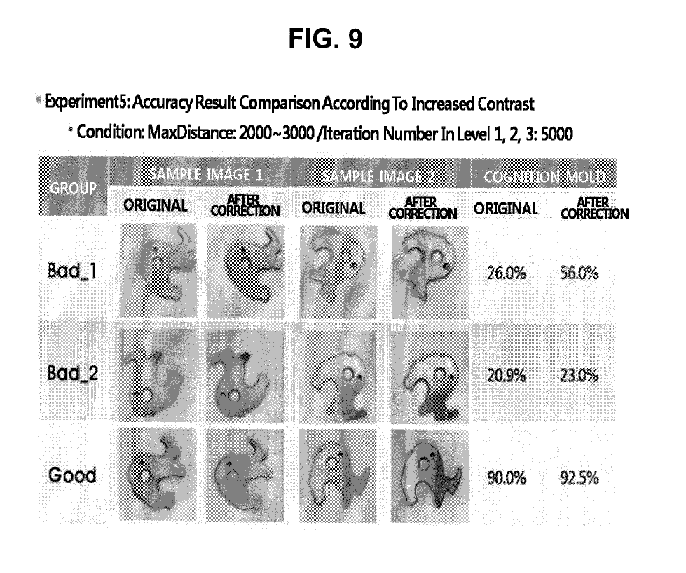

FIG. 9 shows a result of changes of accuracy according to the heightened contrast performed in the second manipulation step (S154″).

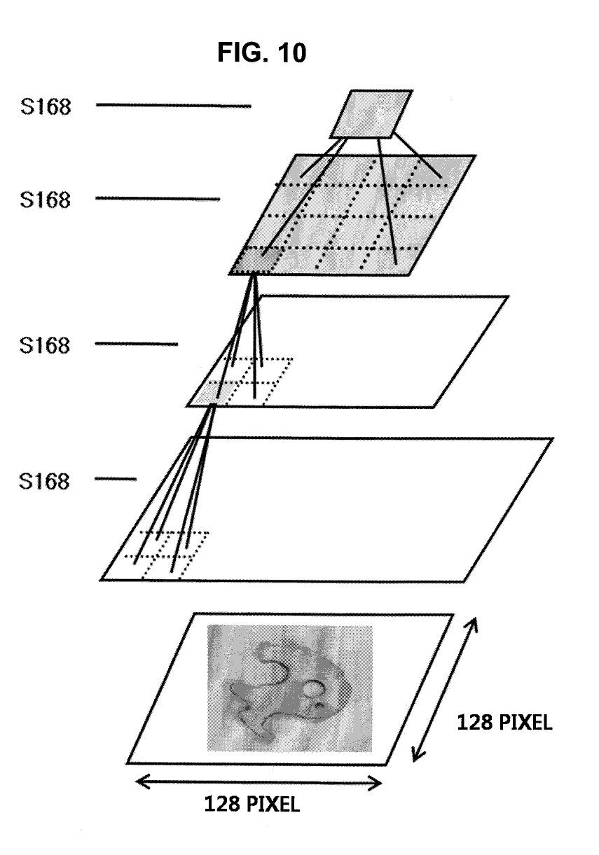

As shown in FIG. 10, in case of increasing contrast, the percentage of recognition is increased entirely. The recognition percentage of Bad 1 is increased by 26.0%->56.0% and the recognition percentage of Bad 2 is increased by 20.9%->23.0% and the recognition percentage of Good is increased by 90.0%->92.5%.

The outline of the product has to be obvious to enhance the accuracy and the contrast is increased to make the outline obvious.

FIG. 10 illustrates the product recognizing stage (S160).

As shown in FIG. 10, the product recognizing stage (S160) includes a first level step (S162), a second level step (S164) and a third level step (S166) and a fourth level step (S168). The first level step (S162) loads the 128×128 pixel image file inputted by the product inspecting stage (S150) and it reads the loaded file in 16×16 Node. The second level step (S164) reads the 16×16 Node converted by the first level step (S162) in 8×8 Node. The third level step (S166) reads the 8×8 Node converted by the second level step (S164) in 4×4 Node. The fourth level step (S168) recognizes the overall image area converted in 4×4 Node at once.

Here, as the level is getting higher as shown in FIG. 10, the number of Nodes is decreased. Four of childnodes are decreased to one of parentnodes in the first level step (S162) to third level step (S166). Overall 16 nodes are added up to a single node in the fourth level step (S168) such that the entire image area may be recognized at once.

Once the image is confirmed finally, the type of each product is distinguished. Then, the learned images of the corresponding product are compared with the input images and it is determined whether the product having the input images is a good product or failure. This process is the product quality determining stage (S170).

The follow-up stage (S180) processes the failure of the products if the failure is generated and it takes action according to the setting set by the equipment control method setting stage (S140).

The follow-up stage (S180) includes an equipment controlling step (S182) and an external notifying step (S184). The equipment controlling step (S182) stops the equipment to operate if the failures are generated more than predetermined number of times. If the failures are generated more than predetermined number of times, the external notifying step (S184) makes alarm and it notifies the current situation to the remote user via SMS simultaneously.

Specifically, if the failures are generated continuously as mentioned in the equipment control method setting stage (S140), the equipment is stopped to operate and this situation is notified outside via buzzer and to the remote user via SMS simultaneously. That is, if three failures are generated continuously, the equipment is stopped to operate and this failure situation is notified outside.

The equipment information inputting stage (S110), the inspection condition setting stage (S120), the quality standard setting stage (S130) and the equipment control method setting stage (S140) may be performed simultaneously or one by one regardless of the order. That is, each of the stages may be performed regardless of the order and the stages may be performed simultaneously.

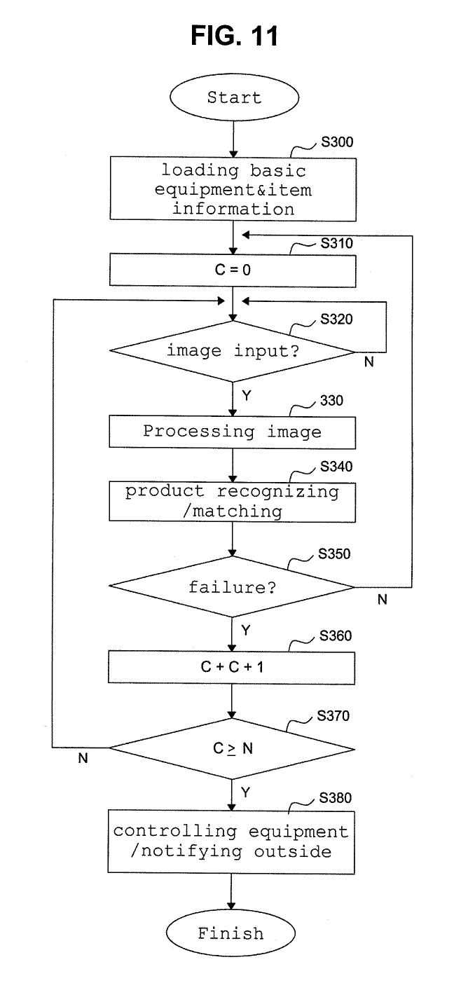

FIG. 11 illustrates a flow chart of the failure recognition system according to the present invention.

As shown in FIG. 11, once the system starts, the basic information related to the equipment and items is loaded (S300). Here, the number of failures (C) showing the number of products determined as failures is set as Zero (S310).

Hence, it is determined whether the image is inputted (S320). If the image is not inputted, it is continuously sensed whether the image is inputted. If the image is inputted, the image processing starts (S330). The image processing step (S330) is corresponding to the product inspecting stage (S150) mentioned above.

Hence, it is determined that the corresponding product is and the product is matched (S340) by the determination standard with respect to the good product or failure determined by the learning of the learning stage (S10). This step is corresponding to the product recognizing stage (S160).

If the input image is matched by and compared with the learned images to determine the failure of the corresponding product, it is determined whether the product is a failure (S350) and this step is corresponding to the product quality determining stage (S170) mentioned above.

If the product is a good product based on the result of this step (S350), it returns to the step (S310) as shown in FIG. 11.

In contrast, if the product is a failure, 1 is added to the failure number (C) (S360) and then it is determined whether the failure number (C) reaches a preset reference number (N) (S370). That is, the user identifies and determines whether the failure number reaches the continuous failure reference number (N) set in the equipment control method setting stage (S140) (S370).

If the continuous failure number (C) does not reach the reference number (N) based on the result of the step (S370), it returns to the above step (S320).

If the continuous failure number (C) reaches the reference number (N), the follow-up stage (S180) is performed (S380). That is, the user may stop the operation of the equipment according to the setting and this situation is notified outside via buzzer and to the user via SMS simultaneously.

If the failure situation is transferred to the user, the user identifies the failure situation of the products directly and examines the equipment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1-11. (canceled)

12. A failure recognition system comprising:
a learning stage for learning and acquiring information related to a good product and a failure of the product;
a setting stage for setting reference information to determine a failure of the product;
a product inspecting stage for inspecting an item based on the reference set in the setting stage;
a product recognizing stage for recognizing an item and type of product by specifying an image of the item measured in the product inspecting stage;
a product quality determining stage for determining, from the image recognized in the product recognizing stage, whether the item is a good product or a failure based on the information acquired in the learning stage; and
a follow-up stage for outside notification of a failure and control of equipment according to a control method set in the setting stage.

13. The failure recognition system of claim 12, wherein the learning stage comprises,
an item selecting step for selecting an item to learn;
a type determining step for determining whether the item requires new learning or continuous learning;
a category forming step for forming a new category when new learning is required based on the result of the type determining step;
a category selecting step for selecting an existing continuous category when continuous learning is required based on the result of the type determining step;
a ratio selecting step for selecting a ratio of the number of data to learn according to each category;
a folder selecting step for selecting a folder to store image data learned according to each category;
an inputting step for storing an input image;
a testing step for testing by using a rear product;
an identifying step identifying the result of the testing step;
a result determining step for determining whether the test result identified in the identifying step satisfies a required learning result value; and
a storing step for storing the learning result when the required learning result value is satisfied based on the result of the result determining step.

14. The failure recognition system of claim 12, wherein when the required learning result value is not satisfied based on the result of the result determining step, an adjusting step is performed for identifying and adjusting the reason why the required value is not satisfied.

15. The failure recognition system of claim 13, wherein the inputting step determines whether the product is a good product or a failure by inputting images stored in advance.

16. The failure recognition system of claim 13, wherein the inputting step receives and stores an image of one of a real good product and a failure inputted via a sensor.

17. The failure recognition system of claim 13, wherein the ratio of the image data learned in a type of Good:Bad 1:Bad 2 is 4:1:1 in the ratio selecting step.

18. The failure recognition system of claim 12, wherein the setting stage comprises:
an equipment information inputting step for inputting production equipment information for products and sensor information related to a sensor for measuring environmental conditions including at least one of pressure and temperature;
an inspection condition setting step for setting at least one of a temporal condition and a quantity condition to perform inspection of the product;
a quality standard setting step for loading the information learned in the learning stage that is a determination reference to determine whether each of the products is a one of a good product and a failure;
an equipment control method setting step for setting a control method for controlling the operation of the equipment when a failure is generated,
wherein the equipment information inputting step, the inspection condition setting step, the quality standard setting step and the equipment control method setting step are performed simultaneously or each of the steps is performed regardless of an order.

19. The failure recognition system of claim 12, wherein the product inspecting stage comprises:
image reading for reading an image by photographing an image of the product;
image editing for editing the image read in the image reading; and
image storing for storing an image manipulated in the image editing.

20. The failure recognition system of claim 19, wherein the image editing comprises:
a first manipulation step for converting the image read by the image reading, the first manipulation step locating an outline of each product and cutting each area simultaneously; and
a second manipulation step for adjusting brightness and contrast of the image having passed the first manipulation step to help the image determination to be performed smoothly.

21. The failure recognition system of claim 12, wherein the product recognizing stage comprises:
a first level step for loading a 128×128 pixel image file inputted by the product inspecting stage and reading the loaded file in a 16×16 node;
a second level step for reading the 16×16 node converted by the first level step into an 8×8 node;
a third level step reading the 8×8 node converted by the second level step into a 4×4 node;
a fourth level step recognizing the overall image area converted into a 4×4 node at once.

22. The failure recognition system of claim 12, wherein the follow-up stage comprises:
an equipment controlling step for stopping the equipment when a failure is generated more than a predetermined number of times; and
an external notifying step for generating an alarm and transferring a current situation to a remote user via SMS when a failure is generated more than a predetermined number of times.
